(19) United States
(12) Patent Application Publication
(10) Pub. No.: US 2003/0218539 A1
(43) Pub. Date: Nov. 27, 2003

(54) Location tracking apparatus, system, and method

(76) Inventor: Myra R. Hight, Zepher Cove, NV (US)

Correspondence Address: Brian C. Kunzler, Suite 450, 10 West 100 South, Salt Lake City, UT, 84101, US

(21) Appl. No.: 10/443,559

(22) Filed: May 21, 2003

Related U.S. Application Data
(60) Provisional application No. 60/382,909, filed on May 22, 2002.

(51) Int. Cl. G08B 1/08

(52) U.S. Cl. 340/539.13; 340/573.4

(57) ABSTRACT

An apparatus, system, and method are disclosed for tracking the location of one or more target tracking apparatus with a master tracking apparatus. The master tracking apparatus communicates with the target tracking apparatus via radio frequency (RF) signals. The target tracking apparatus includes a tamper-resistant band and closure that are designed to resist unauthorized removal from the target subject and to alert the master operator of an attempted or completed unauthorized removal. The master tracking apparatus and the target tracking apparatus are each capable of initiating one or more alarm modes based on certain alarm events, such as activation of a distress alarm initiator by the target subject or activation of a check-in selector control by the master operator. Upon occurrence of an alarm event, the master and target tracking apparatus each communicates an alert signal to the other apparatus and each notifies the master operator or target subject of the occurrence of the alarm event.

### RELATED APPLICATIONS

This application is a continuation-in-part of and claims priority to U.S. Provisional Patent Application No. 60/382,909 entitled “Child Locator System” and filed on May 22, 2002 for Myra Hight, which is incorporated herein by reference.

### BACKGROUND OF THE INVENTION

1. Field of the Invention

The invention relates to location tracking of persons and pets, and more particularly pertains to a master tracking apparatus and one or more target tracking apparatus employing radio frequency (RF) signals for communicating alarm events and determining distance and radio direction finding as part of a system for tracking persons or animals.

2. Description of Related Art

Many products are available to assist in locating persons, animals, and inanimate articles. These products are directed to locating inanimate objects, such as keys and television remote controls using receiving devices attached to the inanimate object. Upon receiving a signal from a transmitting device, the receiving device typically sounds an audible tone to aid a person in finding the inanimate object. These products are also directed to locating pets, such as hunting dogs. In this case, a device may be attached to a collar and another device may be employed by a person to locate the dog. These products are also directed to verifying the presence of a person within a designated area, such as prisoners or parolees. In such a case, a device may be attached to a person to be monitored, and if a monitoring signal is not received from the device, a base unit monitor may alert a user that the person is not within the designated area.

Unfortunately, the related art in this field does not adequately provide for all of the needs of users of proper location tracking systems. The related alt that is available does not provide adequate protection against unauthorized removal of the receiver or transceiver attached to the person or animal to be tracked. Without requiring authorization to remove the device or providing obstacles against the removal of the device, a location tracking device could easily be removed from the person or animal, either purposefully or by accident, and discarded, leaving the tracking device worthless as to its tracking ability. While some of the prior art encountered does discuss limited measures to make removal of the tracking device difficult, those devices do not allow dynamic tracking of the location of a person or animal, but rather simply monitor the presence of a person within a designated area.

The prior art also fails to implement many of the alarm capabilities that allow the operator of either a monitoring device or a monitored device to manually initiate multiple alarms that may notify the other party of the activated alarm event.

What is needed is a process, apparatus, and system that allows a master operator to track the location, including distance and direction, of a target subject. Beneficially, such a process, apparatus, and system should be implemented in a manner that allows a master operator to send messages to and receive messages from the target subject. Also, the process, apparatus, and system are preferably designed to resist attempts at unauthorized removal of the target tracking apparatus from the target subject, as well as notify the master operator of such attempts.

### BRIEF SUMMARY OF THE INVENTION

The present invention has been developed in response to the present state of the art, and in particular, in response to the problems and needs in the art that have not yet been fully solved by currently available location tracking systems and methods. Accordingly, the present invention has been developed to provide a process, apparatus, and system for tracking the location of a target Subject that overcome many or all of the above-discussed shortcomings in the art.

The target tracking apparatus is provided with a logic unit containing a plurality of modules configured to functionally execute the necessary steps of tracking the location of a target subject. These modules in the described embodiments include a transceiver module, a vibration module, a frequency module, a GPS module, a user input module, a user output module, and an alarm module. The user input module in the described embodiments includes an audio input module, a selection module, a distress input module, and an audio call module. The user output module in the described embodiments includes an audio output module, a visual indicator module, and a display module. The alarm module in the described embodiments includes an audio call alarm module, a band tamper alarm module, a suspect exit module, a distress alarm module, a check-in alarm module, and an out-of-range alarm module.

The target tracking apparatus, in one embodiment, is configured to communicate via radio frequency (RF) signals with a corresponding master tracking apparatus. The target tracking apparatus may transmit RF signals to the master tracking apparatus in response to an inquiry signal received by the target tracking apparatus from the master tracking apparatus. Alternatively, the target tracking apparatus may transmit RF signals to the master tracking apparatus in response to an alarm event initiated by the target subject or automatically by the target tracking apparatus.

For example, the target tracking apparatus, in one embodiment, includes a tamper-resistant security band that resists unauthorized removal from the target subject. If unauthorized removal, or an unauthorized attempted removal, is detected by a sensor in the band and closure, the target tracking apparatus may automatically employ the band tamper alarm module to invoke a band tamper alarm mode and transmit a band tamper alert signal to the master tracking apparatus.

The apparatus is further configured, in one embodiment, to communicate over a global positioning system (GPS) network via the GPS module to obtain GPS coordinates of the target tracking apparatus and target subject. The obtained GPS coordinates may subsequently be transmitted to the master tracking apparatus and master operator.

In a further embodiment, the distress alarm module of the target tracking apparatus maybe configured to initiate a distress alarm mode and transmit a distress alert signal to the master tracking apparatus. For example, the distress alarm module may detect the activation of a distress alarm initiator by the target subject and transmit a distress alert signal to the master tracking apparatus to alert the master operator to the occurrence of the distress alarm event.

In a further embodiment, the audio call alarm module of the target tracking apparatus may be configured to allow the target subject to record an audio signal using an audio input module, including a microphone, and transmit the recorded audio signal to the master tracking apparatus. The transmitted audio message may be stored on an electronic storage device within the master tracking apparatus, and the master operator may play back the recorded audio message.

In a further embodiment, the check-in alarm module of the target tracking apparatus may be configured to process a check-in signal received from the master tracking apparatus and alert the target subject of the occurrence of a check-in alarm. For example, the master operator may initiate a check-in alarm event and request that the target subject check in with the master operator. The target subject may then, in one embodiment, check in with the master operator via employment of the audio call alarm event described above. In an alternative embodiment, the target subject may physically move to a designated area or within sight of the master operator.

In a further embodiment, the out-of-range alarm module of the target tracking apparatus may be configured to process an out-of-range signal received from the master tracking apparatus and alert the target subject of the occurrence of an out-of-range alarm. For example, if the target subject moves beyond a predetermined threshold distance away from the master tracking apparatus and master operator, the target tracking apparatus may notify the target user that the threshold distance has been exceeded.

In a further embodiment, the suspect exit alarm module of the target tracking apparatus may be configured to send a suspect exit alert signal to the master tracking device in response to a suspect exit alarm event. For example, if the target subject exits a designated area passing an exit control point without an accompanying master tracking apparatus, the target tracking apparatus may initiate a suspect exit alarm mode and transmit a suspect exit alert signal to the master tracking apparatus, notifying the master operator of the occurrence of a suspect exit.

A system of the present invention is also presented for tracking the location of a target subject. The system described may be embodied in a person tracking system or an animal tracking system. The system described may also be embodied in a tracking system for tracking the location of an inanimate object. In particular, the system, in one embodiment, includes a target tracking apparatus attached to a target subject and a master tracking apparatus administered by a master operator. In fact, the system may include multiple target tracking apparatus in communication with a single master tracking apparatus.

The system may further include an additional master tracking apparatus administered by an emergency services operator, such as a police officer. The system may also include one or more exit control points as discussed above in connection with the suspect exit alarm module.

A process of the present invention is also presented for tracking the location of a target subject. The process in the disclosed embodiments substantially includes the steps necessary to carry out the functions presented above with respect to the operation of the described apparatus and system. In one embodiment, the process includes attaching a target tracking apparatus to the target subject to be tracked. As described above, the target subject may be a person, an animal, or an inanimate object. The process also includes monitoring the location, including the distance and direction, of the target tracking apparatus with the use of a master tracking apparatus.

The target tracking apparatus and master tracking apparatus send and receive RF communication is between one another using one or more RF transmission protocols. Based on the measured time of flight and the propagation speed of the transmission signals, the distance between the master tracking apparatus and target tracking apparatus may be calculated. The direction from the master tracking apparatus to the target tracking apparatus may also be determined. In one embodiment, the direction to the target tracking apparatus is determined by measuring the signal strength of a response signal received by multiple antennas at the master tracking apparatus and determining the direction toward a calculated maximum signal strength in an alternative embodiment, the master tracking apparatus and target tracking apparatus communicate GPS coordinates and other GPS status information that may be used to determine the distance and direction to the target tracking apparatus.

The location tracking process in a further embodiment includes initiating an alarm mode at either the target tracking apparatus or the master tracking apparatus and communicating a corresponding alert signal to the corresponding apparatus.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view showing one manner of using a location tracking system in accordance with the present invention;

FIG. 2 is a perspective view of one embodiment of a target tracking apparatus in accordance with the present invention;

FIG. 3 is a perspective view of one embodiment of a master tracking apparatus in accordance with the present invention;

FIG. 4 is a schematic block diagram illustrating one embodiment of a target tracking apparatus in accordance with the present invention;

FIG. 5 is a schematic block diagram illustrating one embodiment of a master tracking apparatus in accordance with the present invention;

FIG. 6 is a schematic flow chart diagram illustrating one embodiment of a method for locating a target tracking apparatus in accordance with the present invention;

FIG. 7 is a schematic flow chart diagram illustrating one embodiment of a method for processing a target alarm event in accordance with the present invention; and

FIG. 8 is a schematic flow chart diagram illustrating one embodiment of a method for processing a master alarm event in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

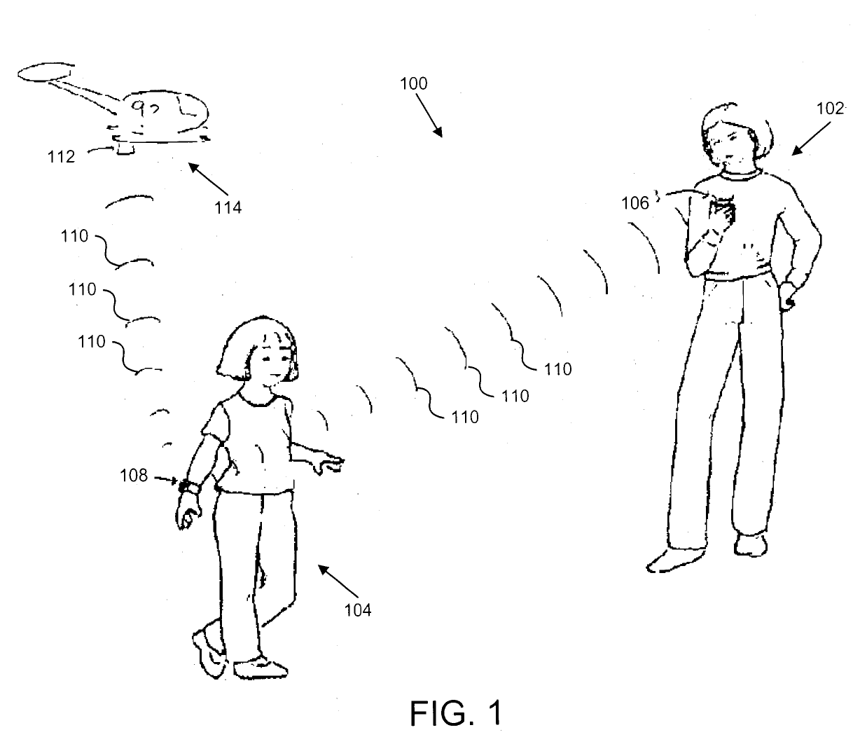

FIG. 1 depicts a perspective view of a location tracking system 100. The illustrated location tracking system 100 includes a master operator 102 and a target subject 104. The master operator 102 may be a parent or another person who is tracking the location of the target subject 104. The target subject 104 may be a child. Alternatively, the target subject 104 may be another adult, such as an elderly person. The target subject 104 may also be animal or an inanimate object.

The master operator 102 operates a master tracking apparatus 106 that, in one embodiment, is a portable, handheld device. A corresponding target tracking apparatus 108 is securely attached to the target subject 104. In the depicted embodiment, the target tracking apparatus 108 is attached to the wrist of the target subject 104. In an alternate embodiment, the target tracking apparatus 108 may be attached to the ankle, leg, waist, arm, chest, or neck of the target subject 104. For example, in the case of an animal as the target subject 104, the target tracking apparatus 108 may be embodied in the form of a secure collar band.

The master tracking apparatus 106 is configured to send and receive radio frequency (RF) signals 110 with one or more target tracking apparatus 108. For example, one master tracking apparatus 106 may be configured to distinctly track three separate target tracking apparatus 108 attached to three separate target subjects 104. The master tracking apparatus 106 and the target tracking apparatus 108 communicate with each other via RF signals 110 such that allow the master tracking apparatus 106 to determine the approximate distance and direction to the target tracking apparatus 108. The RF signals 10 may further include status and alarm information. The alarm RF signals 110 may be initiated by either the master tracking apparatus 106 or the target tracking apparatus 108, depending on the type of alarm, as discussed in detail below.

In a further embodiment, the location tracking system 100 includes an additional master tracking apparatus 112 that may be employed by an emergency services operator 114, such as a mobile police unit or the like. The additional master tracking apparatus 112 is substantially similar in function to the master tracking apparatus 106 used by the master operator 102. Further reference to the master tracking apparatus 106 is intended to reference either the master tracking apparatus 106 or the additional master tracking unit 112.

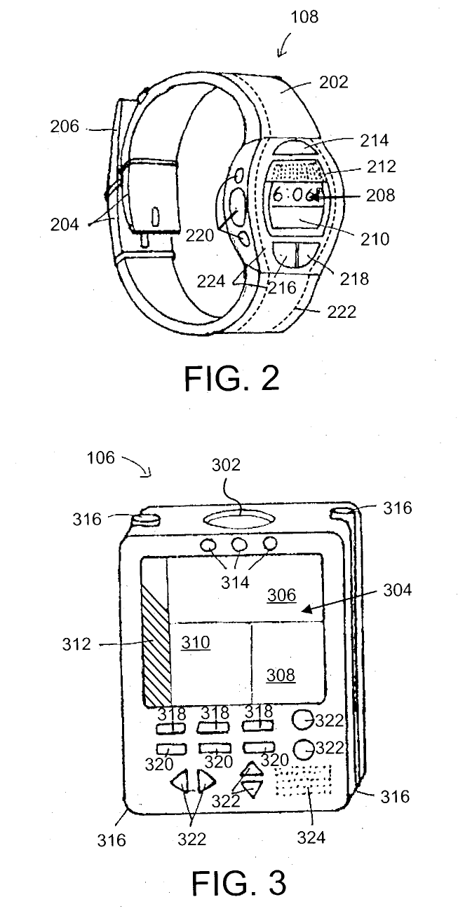

FIG. 2 depicts a perspective view of one embodiment of a target tracking apparatus 108 that is substantially similar to the target tracking apparatus 108 of FIG. 1. The illustrated target tracking apparatus 108 includes a tamper-resistant band 202 with a locking closure 204 and an adjustable length 206. The band 202 may be made of Kevlar or a similar material. The closure 204 is configured to lock and resist removal without authorization. In one embodiment, authorization for removal is acquired electronically from the master tracking apparatus 106. The closure 204 may also include an electronic sensor (not shown) to acquire the status of the closure 204: open, locked, damaged, etc. In one embodiment, the status of the closure 204 may be transmitted to the master tracking apparatus 106 via the RF signals 110.

The depicted target tracking apparatus 108 also includes a user interface 208. The user interface 208 comprises a visual display 210, an audio circuit 212, a “distress” alarm initiator 214, a “call” alarm initiator 216, a power control 218, and several selector controls 220. The visual display 210 may be configured to display text messages, battery power levels, time, temperature, GPS coordinates, vital sign statistics, and other similar information. The visual display 210 may also include one or more visual indicators (not shown) that indicate various alarm events. In one embodiment, a display background light (not shown) illuminates the background of the display and serves as an indicator light. In another embodiment, the visual indicators may be separately housed LED indicators displayed along the face or sides of the target tracking apparatus 108.

The audio circuit 212, in one embodiment, includes an audio speaker and a microphone. The audio speaker may be used to communicate pre-recorded audio messages, audible alarm signals, or real-time messages transmitted from the master tracking apparatus 106. The microphone of the audio circuit 212 may be configured to receive audible input from the target subject 104 or another person. The audible input may be stored in the memory of the target tracking apparatus and may further be transmitted to the master tracking apparatus 106. In one embodiment, the audible input is recorded upon activation of the “call” alarm initiator 216, such as by depressing a button. The recorded audible input may then be automatically transmitted (immediately or after a predetermined time delay) to the master tracking apparatus 106 or may be stored in the target tracking apparatus 108 until the “call” alarm initiator is activated again.

The “distress” alarm initiator 214 may be activated by the target subject 104 or another person. Once activated, the target tracking apparatus transmits a distress alert signal to the master tracking apparatus 106. In one embodiment, the “distress” alarm initiator 214 may be activated by simply pressing a button. In an alternative embodiment, activation of the “distress” alarm initiator 214 may require user authentication, such as an identifiable fingerprint or other method of identification, including a pre-determined activation sequence comprising an orderly depression of specific selector controls 220.

The power control 218 may be configured to require authorized initiation from the master tracking apparatus 106 to turn on or turn off the target tracking apparatus 108. In a further embodiment, the power control 218 may also allow the master operator 102 or target subject 104 to select a power level appropriate to the distance between the target tracking apparatus 108 and the master tracking apparatus 106. For example, when the target tracking apparatus 108 is near the master tracking apparatus 106, the power control 218 may automatically or manually be adjusted to use less power to transmit RF signals 110 to the master tracking apparatus 106. Similarly, when the target tracking apparatus 108 is far away from the master tracking apparatus 106, the power control 218 may be automatically or manually adjusted to use more power sufficient to transmit RF signals 110 to the master tracking apparatus 106.

The selector controls 220 may be configured to allow a user to select among different displays, activate certain alarm events, set user-controlled functions such as the time, or generally manage the components and functions of the target tracking apparatus 108.

The depicted target tracking apparatus 108 also includes an integral antenna 222 (shown dashed) that may be internal to the band 202 and user interface 208. The target tracking apparatus 108 may include more than one antenna 222, if necessary, to transmit on distinct frequencies or in different directions of propagation. The antenna 222, in one embodiment, is configured to transmit RF signals 110 to the master tracking apparatus 106 and to receive RF signals 110 from the master tracking apparatus 106. In another embodiment, the antenna 222 may be configured to communicate over a global positioning system (GPS) network.

The depicted target tracking apparatus 108 also includes an integral band tamper sensor 224 (shown dashed) that may be internal to the band 202, closure 204, and user interface 208. The band tamper sensor 224 is configured to activate an alarm event that communicates a band tamper alert signal to the master tracking apparatus 106. The band tamper sensor 224 activates the alarm event when unauthorized removal of the band is attempted, such as unauthorized opening of the closure 204 or an attempt to cut or damage the band 202. In one embodiment, the band tamper sensor 224 comprises a wire completing an electronic circuit around the band. An alarm may is activated when the wire circuit is disconnected, such as when the band is cut, without authorization.

FIG. 3 depicts a perspective view of one embodiment of a master tracking apparatus 106 that is substantially similar to the master tracking apparatus 106 of FIG. 1. One master tracking apparatus 106 may be configured to track a plurality of target tracking devices 108. For example, one master tracking apparatus 106 may communicate with and track the location of three or more target tracking apparatus 108 at one time.

The illustrated master tracking apparatus 106 includes a power control 302 that may be similar to the power control 218 of the target tracking apparatus 108. The master tracking apparatus 106 also has a user interface 304 that includes a direction display 306, an alarm mode display 308, a tracking mode display 310, a signal strength display 312, multiple visual indicators 314, a plurality of antennas 316, various selector controls 318, 320, 322, and an audio circuit 324.

The direction display 306 of the user interface 304 may be configured to display a direction from the master tracking apparatus 106 to the target tracking apparatus 108 as determined from the RF signals 110 received from the target tracking apparatus 108. Additionally, the direction display may further be configured to display GPS coordinates of the master tracking apparatus 106 or the target tracking apparatus 108 being tracked. The direction display may further be configured to display a map of the local area in which the master and target tracking apparatus 108, 106 are employed.

The alarm mode 308, in one embodiment, may be configured to display information about an alarm event that is initiated by either the master tracking apparatus 106 or the target tracking apparatus 108. The alarm events are discussed in more detail below.

The tracking mode display 310 may be configured to display information regarding the status of the corresponding target tracking apparatus 108. For instance, the tracking mode display 310 may indicate if the target subject 104 is within a certain distance from the master operator 102. The tracking mode display 310 may be configured further to indicate distance zones, i.e. near, mid, and far ranges, within which the target subject 104 is located. Other information pertinent to the tracking mode may also be displayed.

The signal strength display 312, in one embodiment, is configured to display the signal strength of the RF signals 110 received by the master tracking apparatus 106 from the target tracking apparatus 108. The signal strength may depend on the distance between the master tracking apparatus 106 and the target tracking apparatus 108, as well as the amount and type of obstructions between them. The signal strength may also depend on the output power level of the target tracking apparatus 108.

In an alternative embodiment, the displays 306, 308, 310, 312 may be a single display screen on which the master operator 102 may scroll through views of the information discussed above. For example, the master tracking device may implement a Microsoft Windows™ operating system that allows the master operator 102 to alternate among several windows each showing specific information that may be grouped according to separate target tracking apparatus 108 or may be grouped according to the type of information displayed, i.e. the distances corresponding to all target tracking apparatus 108.

The visual indicators 314 on the master tracking apparatus 106 are preferably substantially similar to the visual indicators (not shown) on the target tracking apparatus 108. The visual indicators 314 may be embodied in the form of separate LED indicators, or may be integrated with the various displays 306, 308, 310, 312 discussed above.

The depicted master tracking apparatus 106 includes one or more antennas 316 that are used to communicate RF signals 110 with the target tracking apparatus 108. The antennas 316 are oriented and configured to also determine the direction from the master tracking apparatus 106 to the target tracking apparatus 108. In one embodiment, the antennas 316 may be internal to the master tracking apparatus 106. In an alternative embodiment, the antennas 316 may be partially or wholly external to the housing of the master tracking apparatus 106.

The master tracking apparatus 106 has a variety of selector controls, including check-in selector controls 318, display selector controls 320, and additional selector controls 322. The check-in selector controls 318, in one embodiment, are configured to allow the master operator 102 to send a check-in signal to the corresponding target tracking apparatus 108. The target tracking apparatus then processes the received check-in signal and notifies the target subject 104, through visual, audible, or vibratory alarm that a check-in signal has been received. The check-in signal and alarms are discussed in greater detail below.

The display selector controls 320 are configured to allow the master operator 102 to display the tracking information for a selected target tracking apparatus 108. The master tracking apparatus 106 subsequently uses one or more displays 306, 308, 310, 312 and indicators 314, to communicate the status of the selected target tracking apparatus 108 to the master operator 102.

The additional selector controls 322 may be used for a variety of selection functions, including scrolling within or between software applications, selecting display information and format, selecting transmission frequencies and protocols, zooming within a GPS map, accessing saved audio files, activating alarm events, accessing tracking log files, and modifying user settings.

The audio circuit 324 of the master tracking apparatus 106 is substantially similar to the audio circuit 212 of the target tracking apparatus 108. The depicted audio circuit 324 includes an audio speaker and a microphone. The audio speaker is configured to communicate an alert to the master operator 102 and to play back a recorded audio file that may be received from the target tracking apparatus 108, via the “call” alarm initiator discussed above.

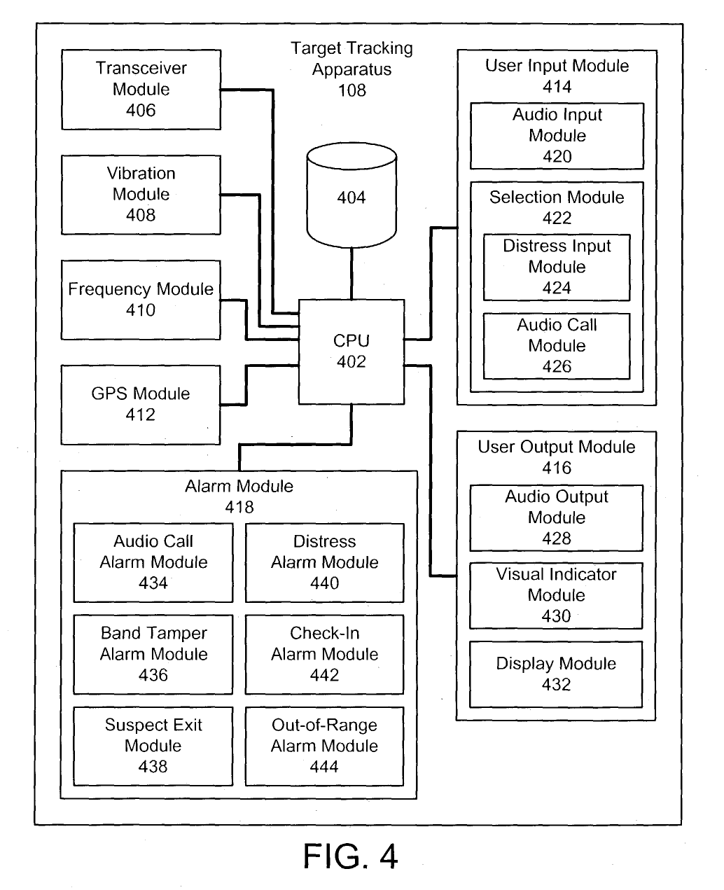

FIG. 4 depicts a schematic block diagram of one embodiment of the target tracking apparatus 108. The illustrated target tracking apparatus 108 includes a central processing unit (CPU) 402, an electronic storage device 404, a transceiver module 406, a vibration module 408, a frequency module 410, a GPS module 412, a user input module 414, a user output module 416, and an alarm module 418.

The CPU 402 is configured to process data requests among the other modules and components with the target tracking apparatus 108. Control instructions for the target tracking apparatus 108 may be stored on the electronic storage device 404. The electronic storage device 404 may also be configured to store additional user information, including user profile preferences and settings, master tracking apparatus 106 information, and audio files containing recorded messages that are transmitted to the master tracking apparatus 106. The electronic storage device 404 may also have additional storage capacity for other information, data, or settings that are relevant to the operation and control of the target tracking apparatus 108.

The transceiver module 406, in one embodiment, is configured to transmit RF signals 110 to the master tracking apparatus 106 and to receive RF signals 110 from the master tracking apparatus 106. The vibration module 408 is preferably configured to cause a vibration notification to alert the target subject 104 to the occurrence of an alarm event. The vibration module 408, in one embodiment, may be preprogrammed to activate for some or all of the possible alarm events. In another embodiment, the vibration module 408 may selectively activate the vibration notification depending on a set of user preferences. The frequency module 410 is configured to select the transmission and reception frequencies of the target tracking apparatus 108. In one embodiment, the frequency module 410 may transmit and receive over a single, fixed frequency. In an alternative embodiment, the frequency module 410 may transmit RF signals 110 over a single, fixed frequency and receive RF signals 110 over a distinct, fixed frequency.

In a further embodiment, the frequency module 410 may use a channel-hopping protocol in which subsequent transmissions between the master tracking apparatus 106 and the target tracking apparatus 108 occur on a combination of frequencies. The frequency module 410 may also be configured to encrypt outgoing communications and to de-encrypt incoming communications. The frequency module 410 may further be configured to operate on a reserved “guard” channel that is used only for emergency communications between the master tracking apparatus 106 and target tracking apparatus 108.

The GPS module 412 is configured to interface with a GPS network (not shown) to acquire data, such as GPS coordinates of the target tracking apparatus, over the GPS network.

The user input module 414 is configured to accept user input from the target subject 104 or another user. The depicted user input module 414 includes an audio input module 420 and a selection module 422. The audio input module 420, in one embodiment, is configured to allow a user to record via a microphone an audible message that may be stored on the electronic storage device 404 and communicated to the master tracking apparatus 106.

The selection module 422 as shown includes a distress input module 424 and an audio call module 426. The distress input module 424 is configured in one embodiment to allow a user to activate a distress alarm and communicate a distress alarm signal to the master tracking module 106. In one embodiment, the distress input module 424 is activated when a user activates the “distress” alarm initiator 214 on the target tracking apparatus 108. The audio call module 426 is configured to activate the audio input module 420 and, in a further embodiment, send a recorded audio message to the master tracking apparatus 106. In one embodiment, the audio call module 426 is activated when a user activates the “call” alarm initiator 216 on the target tracking apparatus 108. The selection module 422 is also configured to allow a user to manipulate the selector controls 220.

The depicted user output module 416 includes an audio output module 428, a visual indicator module 430, and a display module 432. The audio output module 428 is configured to communicate an audible message to the target subject 104 via an audio speaker. The audible message may comprise an audible tone, a pre-recorded voice message, or any other audible representation that is designed to notify the target subject 104 of an alarm event. The visual indicator module 430 is configured to manage the operation of the visual indicators (not shown) on the target tracking apparatus 108. The display module 432 is configured to interface with the selection module 422 to allow a user to select information to be displayed on the visual display 208.

The depicted alarm module 418 includes an audio call alarm module 434, a band tamper alarm module 436, a suspect exit module 438, a distress alarm module 440, a check-in alarm module 442, and an out-of-range alarm module 444. The audio call alarm module 434, in one embodiment, is configured to allow the target subject 104 to initiate an audio call alarm mode in which the target subject 104 may record an audio message and the target tracking apparatus 108 may transmit the audio message to the master tracking apparatus 106.

The band alarm module 436 is configured to initiate a band tamper alarm mode whenever the band tamper sensor 224 in the target tracking apparatus 108 is activated. In the band tamper alarm mode, the target tracking apparatus 108 sends a band tamper alert signal to the master tracking apparatus 106 to notify the master operator 102 that the band 202, closure 204, or user interface 208 has been tampered with.

The suspect exit module 438 is configured to automatically initiate a suspect exit alarm mode whenever the target tracking apparatus 108 leaves a designated area and passes an exit control point (not shown) without authorization. For example, a child (target subject 104) wearing a target tracking apparatus 108 may activate a suspect exit alarm mode via the suspect exit module 438 if the child attempts to leave a shopping center without a parent (master operator 102) having the accompanying master tracking apparatus 106. Exit control points at designated shopping center exits may sense the unauthorized exit of the target tracking apparatus 108, and communicate with the target tracking apparatus 108 to initiate a suspect exit alarm mode. The target tracking apparatus 108 subsequently may transmit a suspect exit alert signal to the corresponding master tracking apparatus 106 to notify the parent or supervising adult of the suspect exit of the child.

The distress alarm module 440 is configured to allow the target subject 104 to initiate a distress alarm mode in which the target tracking apparatus 108 sends a distress alert signal to the master tracking apparatus 106. In one embodiment, the distress alarm module 440 initiates the distress alarm mode upon sensing activation of the “distress” alarm initiator 214. For example, the target tracking apparatus 108 may initiate the distress alarm mode once the target subject 104 depresses a panic button serving as the “distress” alarm initiator 214.

The check-in alarm module 442 in the illustrated target tracking apparatus 108 is configured to process a check-in alert signal transmitted from the master tracking apparatus 106 and received by the target tracking apparatus 108. The check-in alarm module 442 subsequently notifies the target subject 104 of the occurrence of a check-in alarm event. In one embodiment, the check-in alarm module 442 invokes the vibration module 408 and the user output module 416, including the audio output module 428, visual indicator module 430, and display module 432

The out-of-range alarm module 444 is configured to process an out-of-range alert signal transmitted from the master tracking apparatus 106 and received by the target tracking apparatus 108. Similar to the check-in alarm module 442, the out-of-range alarm module 444 subsequently notifies the target subject 104 of the occurrence of an out-of-range alarm event. In one embodiment, the out-of-range alarm event occurs when the master tracking apparatus 106 determines that the target tracking apparatus 108 has traveled beyond a specified distance from the master tracking apparatus 106. In a further embodiment, the out-of-range alarm event may occur when the target tracking apparatus 108 is determined to be literally beyond the transmission or reception range of the master tracking apparatus 106. This may alternately be determined by the master tracking apparatus 106 if the master tracking apparatus 106 does not receive a response signal from the target tracking apparatus 108 within a specified timeout period.

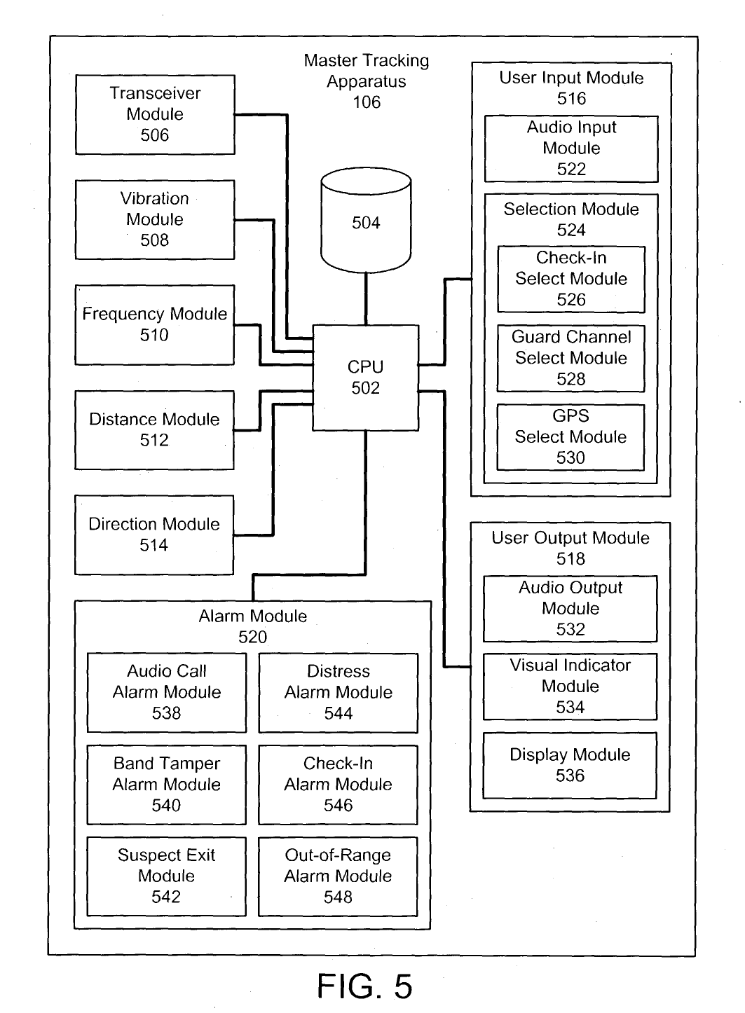

FIG. 5 depicts a schematic block diagram of one embodiment of the master tracking apparatus 106. The illustrated master tracking apparatus 106 includes a central processing unit (CPU) 502, an electronic storage device 504, a transceiver module 506, a vibration module 508, a frequency module 510, a distance module 512, a direction module 514, a user input module 516, a user output module 518, and an alarm module 520.

The CPU 502 is configured to process data requests among the other modules and components with the master tracking apparatus 106. Control instructions for the master tracking apparatus 106 may be stored on the electronic storage device 504. The electronic storage device 504 may also be configured to store additional user information, including user profile preferences and settings, target tracking apparatus 108 information, and audio files containing recorded messages that are transmitted from the target tracking apparatus 108. The electronic storage device 504 may also have additional storage capacity for other information, data, or settings that are relevant to the operation and control of the master tracking apparatus 106.

The transceiver module 506, in one embodiment, is configured to transmit RF signals 110 to the target tracking apparatus 108 and to receive RF signals 110 from the target tracking apparatus 108. The vibration module 508 is preferably configured to cause a vibration notification to alert the master operator 102 to the occurrence of an alarm event. The vibration module 508, in one embodiment, may be preprogrammed to activate for some or all of the possible alarm events. In another embodiment, the vibration module 508 may selectively activate the vibration notification depending on a set of user preferences. The frequency module 510 is configured to select the transmission and reception frequencies of the master tracking apparatus 106. In one embodiment, the frequency module 510 may transmit and receive over a single, fixed frequency. In an alternative embodiment, the frequency module 510 may transmit RF signals 110 over a single, fixed frequency and receive RF signals 10 over a distinct, fixed frequency.

In a further embodiment, the frequency module 510 may use a channel-hopping protocol in which subsequent transmissions between the master tracking apparatus 106 and the target tracking apparatus 108 occur on a combination of frequencies. The frequency module 510 may also be configured to encrypt outgoing communications and to de-encrypt incoming communications. The frequency module 510 may further be configured to operate on a reserved “guard” channel that is used only for emergency communications between the master tracking apparatus 106 and target tracking apparatus 108.

The distance module 512 is configured to calculate the distance between the master tracking apparatus 106 and the target tracking apparatus 108. In one embodiment, the distance module 512 employs a time-of-flight calculation that measures the time between transmission by the master tracking apparatus 106 and reception from the target tracking apparatus 108. Knowing this measured total time and a processing time within the target tracking apparatus 108 and the propagation speed of the RF signals 110, the direction module 512 may calculate an estimated distance from the master tracking apparatus 106 to the target tracking apparatus 108. The processing time is the time required to receive the RF signals 110 at the target tracking apparatus 108, process the received communication, and begin transmission from the target tracking apparatus 108 to the master tracking apparatus 106.

The distance module 512, in one embodiment, may also determine if the distance to the target tracking apparatus 108 is within a specified range, such as near, mid, or far ranges. For example, the distance module 512 may determine that a target tracking apparatus 108 is approximately 75 meters [246.06 feet] away from the master tracking apparatus 106. If the distance module 512 has specified four ranges with delineations at 50 meters [164.04 feet], 100 meters [328.08 feet], and 150 meters [492.13 feet], the distance module 512 would determine that the target tracking apparatus 108 is within the second range of 50 meters [164.04 feet] to 100 meters [328.08 feet]. If, however, the distance module 512 calculated the target tracking apparatus 108 to be 200 meters [656.17 feet] away and beyond the third range of 150 meters [492.13 feet], the master tracking apparatus 106 may initiate an out-of-range alarm mode and alert the target subject 104 that the target subject 104 is beyond the specified range.

The direction module 514 is configured to determine the direction from the master tracking apparatus 106 to the target tracking apparatus 108. The direction module 514 in one embodiment measures the signal strength from each of the antennas 316 and determines the direction to the calculated maximum signal strength. In another embodiment, the direction module is configured to receive and process RF signals 110 from the target tracking apparatus 108 containing GPS coordinates and information regarding the target tracking apparatus 108. In a further embodiment, the direction module 514 is also configured to interface with a GPS network and receive GPS information directly over the GPS network.

The user input module 516 is configured to accept user input from the master operator 102. The depicted user input module 516 includes an audio input module 522 and a selection module 524. The audio input module 522, in one embodiment, is configured to allow a user to record via a microphone an audible message that may be stored on the electronic storage device 504 and communicated to the target tracking apparatus 108.

The selection module 524 includes a check-in select module 526, a guard channel select module 528, and a GPS select module 530. The check-in select module 526 is configured to allow the master operator 102 to notify the target subject 104 that the target subject 104 check in with the master operator 102. For example, the master operator 102 may use the check-in selector controls 318 to individually or collectively request that the target subjects 104 respond to the check-in alert signal. The notified target subject 104 may subsequently call back to the master operator 102 via the audio call alarm module 434 of the target tracking apparatus 108. In an alternate embodiment, the target subject 104 may physically move to the location of or within view of the master operator 102.

The guard channel select module 528 is preferably configured to allow the master operator 102 to select to use the guard channel frequency, as described above. In an alternate embodiment, the master tracking apparatus 102 also may be configured to automatically determine to use the guard channel frequency based on an alarm event or combination of alarm events.

The GPS select module 530 is configured to allow the master operator 102 to select to use a GPS tracking mode, if Such mode is available. The GPS select module 530 may activate or deactivate the G PS module 412 of the target tracking apparatus 108 depending on the needs and selections of the master operator 102.

The depicted user output module 518 includes an audio output module 532, a visual indicator module 534, and a display module 536. The audio output module 532 is configured to communicate an audible message to the master operator 102 via an audio speaker in the audio circuit 212. The audible message may comprise an audible tone, a prerecorded voice message, or any other audible representation that is designed to notify the master operator 102 of an alarm event. The visual indicator module 534 is configured to manage the operation of the visual indicators 314 on the master tracking apparatus 106. The display module 536 is configured to interface with the selection module 524 to allow a user to select information to be displayed on the visual displays 306, 308, 310, 312.

The depicted alarm module 520 includes an audio call alarm module 538, a band tamper alarm module 540, a suspect exit module 542, a distress alarm module 544, a check-in alarm module 546, and an out-of-range alarm module 548. The audio call alarm module 538, in one embodiment, is configured to process an audio message transmitted from the target tracking apparatus 108, as discussed above.

The band tamper alarm module 540 is configured to process a band tamper alert signal received from the target tracking apparatus 108 whenever the band tamper sensor 224 in the target tracking apparatus 108 is activated. In the band tamper alarm mode, the target tracking apparatus 108 sends a band tamper alert signal to the master tracking apparatus 106 to notify the master operator 102 that the band 202, closure 204, or user interface 208 has been tampered with.

The suspect exit module 542 is configured to process a suspect exit alert signal and notify the master operator 102 of the occurrence of a suspect exit alarm event, such as when the target tracking apparatus 108 leaves a designated area or passes an exit control point (not shown) without authorization, as described above.

The distress alarm module 544 is configured to process a distress alert signal received from the target tracking apparatus 108 and notify the master operator 102 of the occurrence of a distress alarm event. In one embodiment, the distress alarm module 440 initiates the distress alarm mode upon sensing activation of the “distress” alarm initiator 214, after which the target tracking apparatus 108 transmits a distress alert signal to the master tracking apparatus 106.

The check-in alarm module 546 in the illustrated master tracking apparatus 106 is configured to initiate a check-in alert mode and transmit a check-in alert signal from the master tracking apparatus 106 to the target tracking apparatus 108. The check-in alarm module 546 subsequently notifies the target subject 104 of the occurrence of a check-in alarm event. In one embodiment, the check-in alarm module 546 invokes the vibration module 408 and the user output module 416, including the audio output module 428, visual indicator module 430, and display module 432, of the target tracking apparatus 108.

The out-of-range alarm module 548 is configured to initiate an out-or-range alarm mode and transmit an out-of-range alert signal from the master tracking apparatus 106 to the target tracking apparatus 108. The out-of-range alarm module 548 subsequently notifies the target subject 104 of the occurrence of an out-of-range alarm event. In one embodiment, the out-of-range alarm event occurs when the master tracking apparatus 106 determines that the target tracking apparatus 108 has traveled beyond a specified distance or range from the master tracking apparatus 106, such as when the target tracking apparatus 108 is determined to be over 150 meters [492.13 feet] away from the master tracking apparatus 106, for example. In a further embodiment, the out-of-range alarm event may occur when the target tracking apparatus 108 is determined to be beyond the transmission or reception range of the master tracking apparatus 106. In one embodiment, the master tracking apparatus 106 may determine that the target tracking apparatus 108 is out of range if the master tracking apparatus 106 does not receive a response signal from the target tracking apparatus 108 within a specified timeout period.

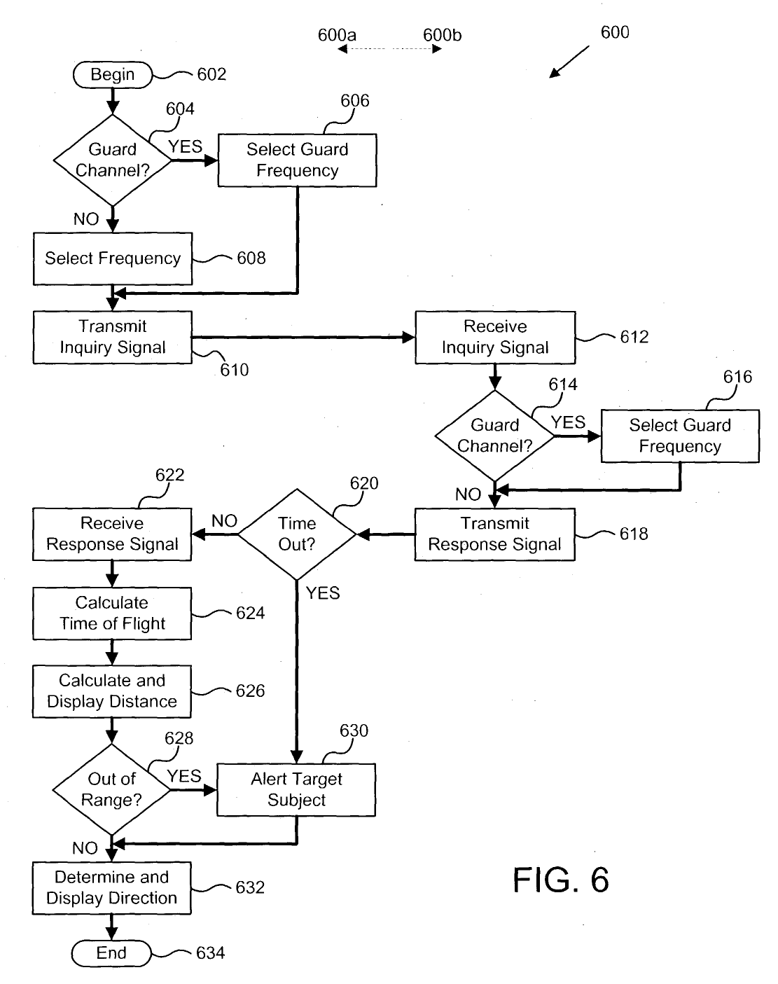

FIG. 6 depicts a schematic flow chart diagram of a location tracking method 600 for locating a target tracking apparatus 108 using a master tracking apparatus 106. The process steps associated with the master tracking apparatus 106 are shown on the first side 600a of the dashed line. The process steps associated with the target tracking apparatus 108 are shown on the second side 600b of the dashed line.

The location tracking method 600 begins 602 as the master tracking apparatus 106 determines 604 if a guard frequency is requested. As described above, the guard frequency may be requested manually by the master operator 102 or automatically by the frequency module 510 of the master tracking apparatus 106. If a guard frequency has been requested, the frequency module 510 selects 606 the guard frequency. Otherwise, the frequency module selects another transmission frequency based on the transmission protocol employed by the master tracking apparatus 106 and target tracking apparatus 108.

After selecting 606, 608 the transmission frequency protocol, the master tracking apparatus 106 uses the transceiver module 506, including one or more antennas 316, to transmit 610 an inquiry RF signal 110 to the target tracking apparatus 108. The target tracking apparatus 108 subsequently receives 612 the inquiry RF signal 110 transmitted 610 from the master tracking apparatus 106. The target tracking apparatus 108 then determines 614 if the inquiry RF signal 110 was transmitted on a guard frequency. If it was, the frequency module 410 of the target tracking apparatus 108 selects 616 the corresponding guard frequency. Alternatively, the target tracking apparatus 108 selects 618 another appropriate transmission frequency. The target tracking apparatus 108 then uses the transceiver module 406, including one or more antennas 222, to transmit 618 a response RF signal 110 back to the master tracking apparatus 106.

After the inquiry RF signal 110 is transmitted 610, the master tracking apparatus 106 determines 620 if a time out period expires before a response RF signal 110 is received. In one embodiment, the time out determination 620 is executed by the distance module 512, which also tracks the time duration until the response RF signal 110 is received 622 by the master tracking apparatus 106. If a response RF signal 110 is received 622 prior to the expiration of a time out period, the distance module 512 calculates 624 a time of flight for the transmission inquiry, processing, and response. Using this calculated 624 time of flight and a known propagation speed of the transmission, the distance module 512 calculates 626 the distance from the master tracking apparatus 106 to the target tracking apparatus 108.

The distance module 512 then determines 628 if the target tracking module 108 is further than a specified range or within a specified alarm range. If the distance module 512 determines 628 that the target tracking module 108 is beyond an acceptable distance, the out-of-range alarm module 548 initiates 630 an out-of-range alarm mode, as described above.

Similarly, if the distance module 512 determines 620 that no response RF signal 110 is received prior to the expiration of the time out period, the out-of-range alarm module 548 initiates 630 an out-of-range alarm mode. In the out-of-range alarm mode, the master tracking apparatus 106 transmits 630 an out-of-range alert signal to notify the target subject that he or she or it is beyond the range of the master tracking apparatus 106.

In a further embodiment of the location tracking method 600, the target tracking apparatus 108 may employ a similar time-out determination (prior to step 612) to determine if an inquiry RF signal 110 is received 612 by the target tracking apparatus 108 prior to expiration of the specified time out period.

When the master tracking apparatus 106 determines 628 that the target tracking apparatus 108 is within range, or after an out-of-range alarm mode has been initiated by the master tracking apparatus 106, the direction module 514 determines 632 the direction from the master tracking apparatus 106 to the target tracking apparatus 108 (assuming that a response RF signal 110 was in fact received by the master tracking apparatus 106). The depicted location tracking method 600 then ends 634.

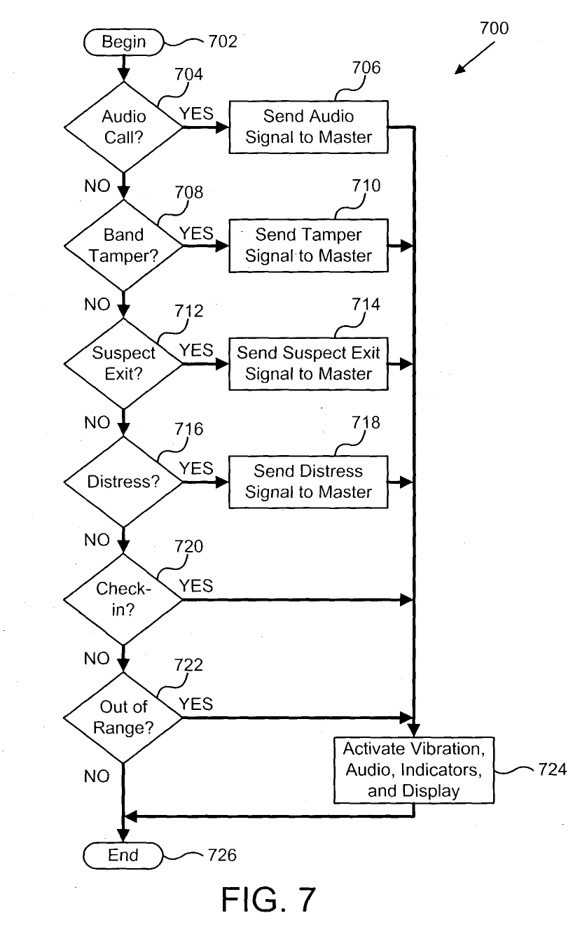

FIG. 7 depicts a schematic flow chart diagram illustrating a target alarm event handling method 700 for processing an alarm event within the target tracking apparatus 108. As described throughout the description above, the present embodiment of the invention includes at least six alarm events: (1) audio call; (2) band tamper; (3) suspect exit; (4) distress; (5) check-in; and (6) out-of-range. Some of these six alarm events may be invoked by either or both the master tracking apparatus 106 or the target tracking apparatus 108. Alternatively, some of the alarm events may be invoked only by the master tracking apparatus 106 and some only by the target tracking apparatus 108.

In brief summary, the target subject 104, in one embodiment, employs the audio call alarm module 434 of the target tracking apparatus 108 to initiate an audio call alarm event in order to send a recorded audio message to the master tracking apparatus 106. In one embodiment the band tamper sensor 224 and the band tamper alarm module 436 of the target tracking apparatus 108 automatically initiate a band tamper alarm event in response to an attempt to tamper with the band 202, closure 204, or user interface 208.

In one embodiment, the suspect exit alarm module 438 of the target tracking apparatus 108 automatically initiates a suspect exit alarm event in response to an unauthorized exit (without the master tracking apparatus 106) from a monitored area and through an exit control point. In one embodiment, the target subject 104 activates the “distress” alarm initiator 214 to employs the distress alarm module 440 of the target tracking apparatus 108 to initiate a distress alarm event and send a distress alert signal to the master tracking apparatus 106.

In one embodiment, the master operator 102 activates the check-in selector control 318 and employs the check-in alarm module 546 of the master tracking apparatus 106 to initiate a check-in alarm event and send a check-in alert signal to the target tracking apparatus 106. In one embodiment, the out-of-range alarm module 548 of the master tracking apparatus 106 automatically initiates an out-of-range alarm event in response to a determination that the target tracking apparatus 108 is either non-responsive to the master tracking apparatus 106 or is beyond a specified distance away from the master tracking apparatus 106.

The target alarm event handling method 700 begins 702 when the target tracking apparatus 108 is activated. Upon activating the target tracking apparatus 108, the alarm monitor 418 monitors the status of the various alarm events. If it is determined 704 that an audio call alarm event occurs, the audio call alarm module 434 initiates an audio call alarm mode and the target tracking apparatus 108 transmits 706 an audio call alert signal to the master tracking apparatus 106. If it is determined 708 that a band tamper alarm event occurs, the band tamper alarm module 436 initiates a band tamper alarm mode and the target tracking apparatus 108 transmits 710 a band tamper alert signal to the master tracking apparatus 106.

If it is determined 712 that a suspect exit alarm event occurs, the suspect exit alarm module 438 initiates a suspect exit alarm mode and the target tracking apparatus 108 transmits 714 a suspect exit alert signal to the master tracking apparatus 106. If it is determined 716 that a distress alarm event occurs, the distress alarm module 440 initiates a distress alarm mode and the target tracking apparatus 108 transmits 718 a distress alert signal to the master tracking apparatus 106.

Whenever any of these alarm modes are initiated, or if either a check-in alert signal or an out-of range alert signal is received from the master tracking apparatus 106, the target tracking apparatus 108 appropriately employs 724 any or all of the following notification modules to notify the target subject 104 of the occurrence of an alarm event: the vibration module 408, the audio output module 428, the visual indicator module 430, and the display module 432. The target alarm event handling method 700 then ends 726.

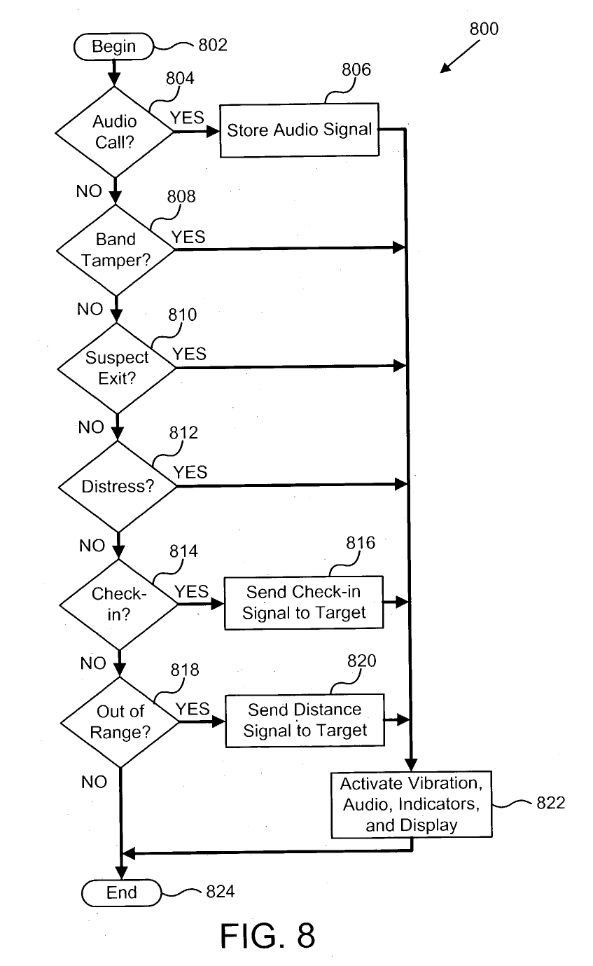

FIG. 8 depicts a schematic flow chart diagram illustrating a master alarm event handling method 800 for processing an alarm event within the master tracking apparatus 106. The master alarm event handling method 800 begins 802 when the target tracking apparatus 108 is activated by the master tracking apparatus 106. Upon activating the target tracking apparatus 108, the alarm module 520 of the master tracking apparatus 106 monitors the status of the various alarm events.

If it is determined 804 that the master tracking apparatus 106 receives an audio call alert signal from the target tracking apparatus 108, the master tracking apparatus 106 stores 806 the received audio signal containing the recorded audio message in the electronic storage 504 for immediate or future playback. If it is determined 814 that a check-in alarm event occurs, the check-in alarm module 546 initiates a check-in alarm mode and the master tracking apparatus 106 transmits 816 a check-in alert signal to the target tracking apparatus 108. If it is determined 818 that an out-of-range alarm event occurs, the out-of-range alarm module 548 initiates an out-of-range alarm mode and the master tracking apparatus 106 transmits 820 a check-in alert signal to the target tracking apparatus 108.

Whenever either of the above alarm modes are initiated, or if an audio call, band tamper, suspect exit, or distress alarm signal is received from the target tracking apparatus 108, the master tracking apparatus 106 appropriately employs 822 any or all of the following notification modules to notify the master operator 102 of the occurrence of an alarm event: the vibration module 504, the audio output module 532, the visual indicator module 534, and the display module 536. The master alarm event handling method 800 then ends 824.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A target tracking apparatus for locating a target subject, the target tracking apparatus comprising:
a radio frequency transceiver configured to receive radio frequency signals from a master tracking apparatus and to transmit radio frequency signals to the master tracking apparatus;
a tamper-resistant security band configured to attach the radio frequency transceiver to a target subject to be tracked and to resist unauthorized removal of the band and transceiver from the target subject; and
a band tamper alarm module configured to send a band tamper alert signal to the master tracking apparatus in response to a band tamper alarm event.

2. The target tracking apparatus of claim 1, wherein the tamper-resistant security band further comprises a locking closure that is configured to resist disengagement of the closure in the absence of an authorized disengagement tool.

3. The target tracking apparatus of claim 1, further comprising a global positioning system (GPS) module configured to obtain a GPS location identifier corresponding to the target tracking apparatus and to allow the target tracking apparatus to send the GPS location identifier to the master tracking apparatus.

4. The target tracking apparatus of claim 1, further comprising a vibration module configured to generate a vibration alert signal in response to a target alarm event and to notify the target subject of the occurrence of the target alarm event.

5. The target tracking apparatus of claim 1, further comprising a distress alarm module configured to allow the target subject to initiate a distress mode and send a distress signal to the master tracking apparatus.

6. The target tracking apparatus of claim 1, further comprising an audio call alarm module configured to allow the target subject to record an audio signal using an audio input module and send the recorded audio signal to the master tracking apparatus.

7. The target tracking apparatus of claim 1, further comprising a check-in alarm module configured to process a check-in signal received from the master tracking apparatus and alert the target subject of the occurrence of a check-in alarm.

8. The target tracking apparatus of claim 1, further comprising an out-of-range alarm module configured to process an out-of-range signal received from the master tracking apparatus and alert the target subject of the occurrence of an out-of-range alarm.

9. The target tracking apparatus of claim 1, further comprising a suspect exit alarm module configured to send a suspect exit alert signal to the master tracking device in response to a suspect exit alarm event.

10. The target tracking apparatus of claim 1, further comprising a frequency module configured to select a transmit frequency and a receive frequency for radio frequency communications with the master tracking apparatus.

11. The target tracking apparatus of claim 10, wherein the frequency module is further configured to select the transmit and receive frequencies using a frequency selection method that is determined by the master tracking apparatus.

12. The target tracking apparatus of claim 11, wherein the frequency selection method uses multiple frequencies in a pseudorandom pattern that is known to the target tracking apparatus and the master tracking apparatus.

13. The target tracking apparatus of claim 10, wherein the frequency module is further configured to select a reserve guard channel frequency for transmitting and receiving radio frequency communications to and from the master tracking apparatus.

14. The target tracking apparatus of claim 1, wherein the tamper-resistant security band is configured to be worn by a human being.

15. The target tracking apparatus of claim 14, wherein the tamper-resistant security band is futher configured in the form of a wristband to be worn around the wrist of a person.

16. The target tracking apparatus of claim 1, wherein the tamper-resistant security band is configured to be worn by an animal.

17. The target tracking apparatus of claim 16, wherein the tamper-resistant security band is further configured in the form of a collar to be worn around the neck of an animal.

18. A location tracking system for locating a target subject, the system comprising:
a target tracking apparatus attached to a target subject, the target tracking apparatus including a target radio frequency transceiver configured to send and receive radio frequency signals; and
a master tracking apparatus configured to track the location of the target tracking apparatus, the master tracking apparatus including:
a master radio frequency transceiver configured to send radio frequency signals to and receive radio frequency signals from the target tracking apparatus;
a distance module configured to calculate the distance between the master tracking apparatus and the target tracking apparatus;
a direction module configured to determine the direction from the master tracking apparatus to the target tracking apparatus.

19. The location tracking system of claim 18, wherein the distance module employs a time-of-flight calculation to calculate the distance between the master tracking apparatus and the target tracking apparatus.

20. The location tracking system of claim 18, wherein the direction module employs Doppler to determine the direction from the master tracking apparatus to the target tracking apparatus.

21. The location tracking system of claim 18, wherein the master tracking apparatus is further configured to distinctly track the location of more than one target tracking apparatus.

22. The location tracking system of claim 18, wherein the master tracking apparatus uses a global positioning system (GPS) to track the location of the target tracking apparatus.

23. The location tracking system of claim 18, wherein the target tracking apparatus is further configured to initiate an alarm mode and transmit an alarm signal to the master tracking apparatus, the alarm signal indicating the alarm mode initiated.

24. A location tracking process for locating a target subject, the process comprising:
attaching a target tracking apparatus to a target subject to be tracked; and
monitoring the location and status of the target tracking apparatus using a master tracking apparatus, including
transmitting radio frequency signals from the master tracking apparatus to the target tracking apparatus;
transmitting radio frequency signals from the target tracking apparatus to the master tracking apparatus in response to the radio frequency signals sent from the master tracking apparatus and received by the target tracking apparatus;
calculating the time-of-flight of the radio frequency signals transmitted from and received by the master tracking apparatus;
calculating a distance between the master tracking apparatus and the target tracking apparatus using the time-of-flight calculation;
determining the direction from the master tracking apparatus to the target tracking apparatus.

25. The location tracking process of claim 24, further comprising initiating an alarm mode at the target tracking apparatus and transmitting an alarm signal to master tracking apparatus, the alarm signal indicating the alarm mode initiated.
